(19) United States
(12) Patent Application Publication
(10) Pub. No.: US 2007/0084793 A1
(43) Pub. Date: Apr. 19, 2007

(54) Method and apparatus for producing ultra-high purity water

(76) Inventor: Nigel Wenden, Livermore, CA (US)

Correspondence Address: THE BOC GROUP, INC., 575 MOUNTAIN AVENUE, MURRAY HILL, NJ, 07974-2064, US

(21) Appl. No.: 11/252,635

(22) Filed: Oct. 18, 2005

(51) Int. Cl. B01D 61/00

(52) U.S. Cl. 210/641; 210/806; 95/241; 96/156; 210/259; 210/652; 210/192; 430/331

(57) ABSTRACT

The present invention relates to a system and method for producing ultrapure water, particular for use in immersion lithography processes. In one embodiment of the present invention, a self contained point-of-use cabinet that can consistently provide ultrapure water for use in immersion lithography equipment is provided. The present invention also relates to a system and method for providing a material having a predetermined specific refractive index to an immersion lithography device.

The present invention relates to a method and apparatus for producing ultrapure water. In particular, the present invention relates to the production of ultrapure water for use in immersion lithography processes. Further, the present invention relates to the production of ultrapure water in a self contained point-of-use cabinet that can consistently provide ultrapure water for use in immersion lithography equipment. The present invention also relates to a system and method for providing a material having a predetermined specific refractive index to an immersion lithography device.

### BACKGROUND OF THE INVENTION

Semiconductor devices have been continuously getting more complex by including greater numbers of components. One significant factor allowing for this increased complexity has been improvements to photolithography, resulting in the ability to print smaller features. Optical lithography which has been the main production technique for semiconductor devices has been nearing a number of physical barriers for several years. In fact, since the mid 1980's, the end of optical lithography as a viable production technique has been predicted to be only a few years away. However, each time optical lithography approaches a limit, new techniques have been developed that extend the useful life of the technology. The use of immersion lithography techniques now offers significant potential to extend the usefulness of optical lithography even further.

Optical lithographic techniques require a beam of light that shines through a mask and exposes a photosensitive material coated onto a semiconductor wafer to create a particular desired layer, e.g. transistor contacts. Following exposure and creation of the entire IC layer, the now soluble portion of the photosensitive material is removed; e.g. rinsed away, and a negative image of the IC layer is left behind. Further processing, such as ion implantation or deposition, can than be carried out, and then the remaining photoresist layer is removed. As noted above, the limits for optical systems have been nearing the useful limit for many years. In particular, optical lithography systems have a resolution limit; i.e. a minimum feature size, that can be achieved as determined by the Rayleigh equation:
W=k1λ/NA

where, k1 is the resolution factor, λ is the wavelength of the exposing radiation and NA is the numerical aperture. With the shrinking of linewidths, the exposing wavelength has also shrunk.

For example, state-of-the-art semiconductor devices from the 1980's had linewidths of 1.2 μm or larger, that could be obtained using a G-line output of mercury lamps (λ=436 nm). For linewidths of 0.8μm generation the I-line output of mercury lamps (λ=365 nm) was introduced. When linewidths were reduced to 350nm, the exposure source of Krypton Fluoride (KrF) Excimer Lasers (λ=248 nm) was adopted and continued to be used through generation of 130 nm linewidths. More currently, 90 nm linewidths have required introduction of Argon Fluoride (ArF) Excimer lasers (λ=193 nm). It may be possible to use fluorine (F2) Excimer lasers (λ=157 nm) for even smaller linewidths, but a number of technical challenges remain to be overcome. For, example, it would be necessary to change the optical exposure systems to be all reflecting optics because wavelengths less than 193 nm are absorbed by the lens material; generally fused silica. All reflective lens exposure systems represent a significant cost in new equipment as well as new technical issues to solve.

While exposure wavelengths have been reduced, lens design improvements have increased NA for the exposure systems lens. For example, NA values of approximately 0.4 were typical in the mid 1980's, while more currently NA values of greater than 0.8 can be achieved. When using air as the medium between the lens and the wafer, the physical limit for NA is 1, while the practical limit is closer to 0.9.

The third element in the Rayleigh equation, k1 is a complex factor of several variables, including photoresist quality, off-axis illumination, resolution enhancement and optical proximity correction. The k1 factor continues to fall with system improvements, although the practical lower limit is thought to be about 0.25.

Using the above limitations, the resolution limit for 193 nm exposure systems may be calculated using the Rayleigh equation as follows:
W=(0.25×193)/0.9=54 nm

Thus, a highly optimized ArF exposure system may be sufficient for 65 nm linewidths but would not be capable of producing the forecasted 45 nm linewidths. The technical challenges related to 157 nm and shorter wavelength exposure systems make extension of the usefulness the 193 nm exposure systems very desirable.

One method for potentially increasing the useful life of 193 nm systems is through immersion lithography. Immersion lithography adds a thin layer of a medium, such as water, between the projection lens and the wafer allowing the printing of narrower lines. In particular, NA in the Rayleigh equation can be increased by using a medium other than air. As noted previously, when using air as the medium between the lens and the wafer, the physical limit of NA is 1. This is because NA is determined by the following equation:
NA=n sin α=d/(2f)

where, n is the index of refraction of the medium surrounding the lens and α is the acceptance angle of the lens. The sine of any angle is always≦1 and n=1 for air, therefore the physical limit for an air based system is 1. However, by using a medium with an index of refraction greater than 1, it is possible to increase NA. However, in addition to a higher index of refraction, the medium must also exhibit low optical absorption at 193 nm, compatibility with the photoresist and the lens material, and be uniform and non-contaminating. Ultrapure water meets all of these requirements; an index of refraction n≈1.47, absorption<5% at working distances up to 6 mm, compatibility with photoresist and lens and uniform non-contaminating nature. By using ultrapure water and assuming a sin α of 0.9, then the resolution limits for 193 nm immersion lithography can be calculated according to the Rayleigh equation as follows:
W=k1λ/n sin α=(0.25×193)/(1.47×0.9)=37 nm

Therefore, the use of ultrapure water as the medium between the lens and wafer makes extension of the 193 nm systems possible. Further advantages may be gained since water has a refractive index very close to that of the fused silica lens material, and therefore light bends less as it passes from the lens to the water than it does in a air based system. This makes increases to the NA possible by building bigger lenses that collect more light.

However, in order for this technology to be effective, the water medium must be ultrapure water and must meet a number of requirements, e.g. essentially no contaminants, particle impurities or dissolved gases, bubble free, temperature and thickness uniformity,

There remains a need in the art for improvements to providing ultrapure water, particularly for use in immersion lithography for the formation of integrated circuits.

### SUMMARY OF THE INVENTION

The present invention provides an apparatus and method of providing ultrapure water capable of meeting the requirements for use in immersion lithography.

Further, the present invention relates to a system for providing ultrapure water and including flow control, wherein the ultrapure water meets the requirements for immersion lithography.

In addition the present invention relates to a system of providing ultrapure water that can be housed in a single cabinet for easy delivery to an immersion lithography tool.

### BRIEF DESCRIPTION OF THE DRAWINGS

FIG. 1 is a schematic drawing of one embodiment of the apparatus according to the present invention.

FIG. 2 is a schematic drawing of an embodiment of the present invention wherein ultrapure water is supplied to an immersion lithography tool through an lithography tool support cabinet.

FIG. 3 is a schematic drawing of an embodiment of the present invention wherein ultrapure water is supplied directly to an immersion lithography tool.

FIG. 4 is a schematic drawing of an embodiment of the present invention wherein ultrapure water is combined with other fluids.

FIG. 5 is a schematic drawing of a further embodiment of the present invention wherein ultrapure water is combined with other fluids.

### DETAILED DESCRIPTION OF THE INVENTION

There are a number of ways to purify water, including filtration, reverse osmosis, deionization, degassification and exposure to ultraviolet light. Each of these processes solves different purification needs. For example, filtration is used to remove particulate mater and contaminants. Different filters can be used to filter different particle sizes, and may be used at multiple stages of a purification process to assure complete removal of particles and contaminants.

Diffusion is the movement of molecules from a section of higher concentration to one of lower concentration. Osmosis comprises a diffusion process wherein water is passed through a semipermeable membrane from lower concentration to higher concentration. The membrane allows passage of water but blocks ions and large molecules; e.g. bacteria, pyrogens and inorganic solids, until equal concentrations are obtained on both sides of the membrane. Reverse osmosis employs pressure to move water against the natural osmotic flow, i.e. from higher concentration to lower concentration. In other words, reverse osmosis can be used to purify water, by applying pressure and forcing the water through the membrane that blocks the passage of ions and large molecules. One example of the use of reverse osmosis is to desalinate seawater. However, reverse osmosis does not eliminate most dissolved gases. There are a number of factors which can effect the performance of reverse osmosis, including feedwater parameters, pressure, pH, LSI (Langlier Saturation Index), membrane parameters, temperature, SDI (Silt Density Index), and turbidity.

Deionization is used to purify water of both cations (positive charge such as sodium (Na+), calcium (Ca++) and magnesium (Mg++)) and anions (negative charge such as chloride (Cl−), sulfates (SO4−) and bicarbonates (HCO3−)) by passing the water through ion exchange resin beds or columns. Cation resins contain hydrogen (H+) that is exchanged for positively charged ions while anion resins contain hydroxide (OH−) that is exchanged for negatively charged ions. The released hydrogen and hydroxide then combine to form water molecules. Deionization can be carried out in separate beds where the reactions are independent and generally incomplete, or in mixed beds where the reactions are simultaneous and the water produced is virtually ion free. Deionization works well for removing dissolved solids and gas ions.

Degassification techniques are used to remove gases from water. Membrane contactors, such as micro porous hollow fiber membranes are used to bring the liquid and gas phases in direct contact. These membranes are hydrophobic so that water will not flow through the pores. In operation, water flows on the outside of the membrane and the gases flow on the inside of the hollow fiber and may then be removed. Degassification works well to remove gases, such oxygen and carbon dioxide.

Water is also purified by exposure to ultraviolet light. Such exposure generates ozone, which is a highly effective oxidizer. Ozone can be used to destroy algae, viruses and bacteria and produces non-harmful by-products. In addition, ozone breaks down other chemicals and acts as a flocculent to suspend dissolved solids and allow for easy removal by filtration. A further advantage of ozone is that it oxidizes combined chlorine and bromine and allows for removal from the water.

In order for water to be useful as a medium for immersion lithography, the water must be ultrapure and also must be readily available to the lithography tools. In particular, the ultrapure water has to be within a very tight tolerance specification in order to achieve the level of performance required for the immersion lithography system. For example, the ultrapure water should have a constant refractive index and particle concentration less than<0.1 μm. Further the ultrapure water should be bubble free and thermally stabile (Delta T˜0.05K). The specific parameters needed for a specific immersion lithography process will be determined by the process operators. The system and method of the present invention will be able to provide ultrapure water meeting any such parameters.

The present invention provides a stable consistent supply of ultrapure water to the immersion lithography tool and thus helps ensure a consistent repeatable lithography process. The present invention provides an apparatus and method for providing water to a level needed for immersion lithography, and also provides a single cabinet that may house all of the necessary purification units. In particular, the present invention comprises a combination of several purification units, each of which provides a different purification function necessary to meet the ultrapurity required for immersion lithography.

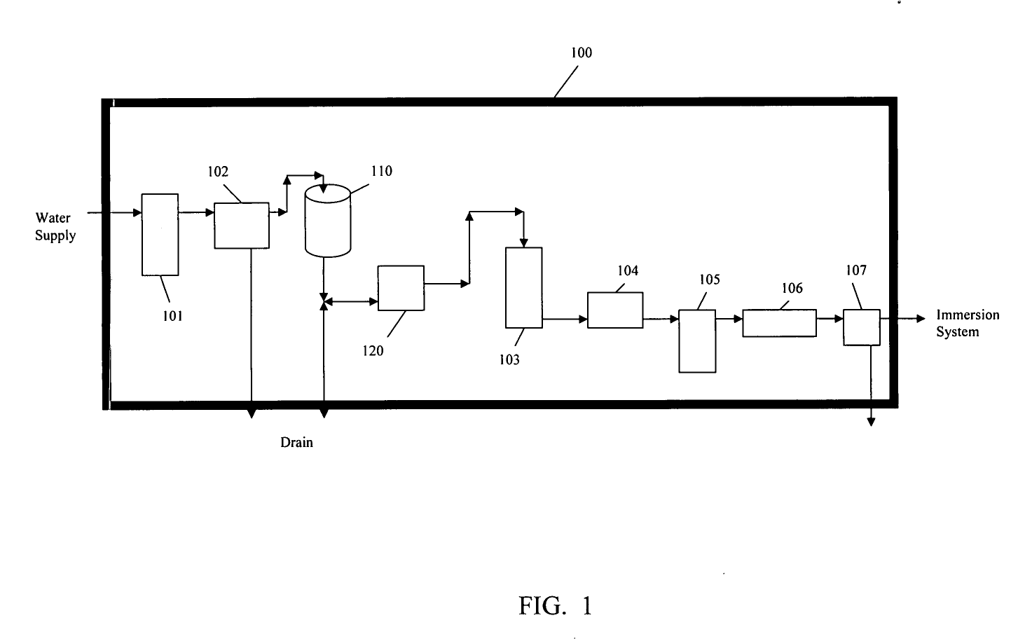

For example, one embodiment of the present invention is shown in FIG. 1, wherein a single cabinet 100, houses a number of different purification units. Shown in FIG. 1 are a prefilter 101, a reverse osmosis unit 102, a deionization polisher 103, an ultraviolet light unit 104, a secondary filter 105, a degasser 106 and an ultrafilter 107. Other elements include a storage vessel 110 and a pump 120. In the embodiment shown in FIG. 1, source water, that can be provided form a local water supply, is introduced to the cabinet 100, and is first filtered by prefilter 101. The prefiltered water is then processed by reverse osmosis unit 102 to remove some ions and large molecules, and is then sent to a storage vessel 110 until needed by an immersion lithography tool. Once required, the water from the storage vessel 110 is pumped to the deionization polisher 103 to remove dissolved solids and gas ions. The deionized water is then processed by the ultraviolet light unit 104 to remove other impurities and suspend dissolved solids that can be removed by the secondary filter 105. The processed water is then degassed by degasser 106 and finally filtered using ultrafilter 107 prior to exiting cabinet 100 as ultrapure water ready for use in an immersion lithography tool. The reverse osmosis unit 102 and the storage vessel 110 also allow for water to be discarded from the cabinet 100 to a suitable drain if necessary, such as after a predetermined time period if not required by an immersion lithography tool.

The embodiment shown in FIG. 1 is only one configuration of the purification units shown and other arrangements may be utilized. For example, the prefiltration or the reverse osmosis may be performed outside the cabinet 100 and initially processed water can be stored in a vessel remote from the cabinet 100 until required by an immersion lithography tool.

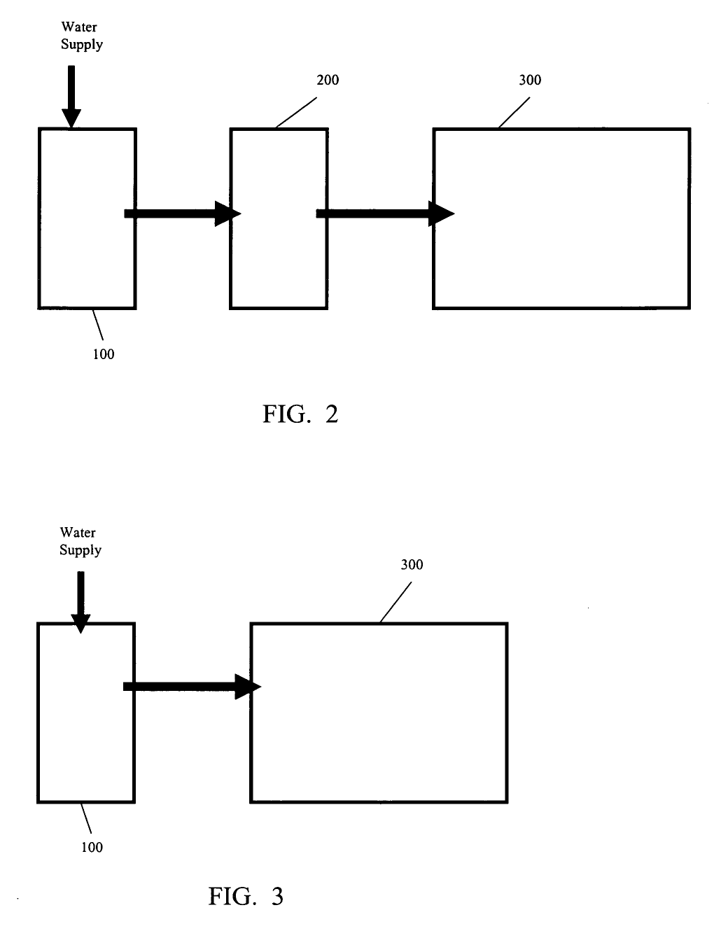

FIGS. 2 and 3 show different configurations of the present invention. In particular, in the embodiment shown in FIG. 2, the ultrapure water leaving the cabinet 100 is first sent through a lithography support cabinet 200 prior to being introduced to an immersion lithography tool 300. The embodiment shown in FIG. 3 introduces the ultrapure water directly to the immersion lithography tool 300 from the cabinet 100. Additional operational control elements can also be included in the apparatus, such as, pressure and temperature controls, fluid flow control devices, valves (manual, shut off, pneumatic), mixers or blenders, flow restrictors, non return valves, flow meters and Ph probes.

In a further aspect of the present invention, dopants may be added to the ultrapure water to further alter the refractive index and provide specific line width capabilities. In order to be effective, the water must still meet the requirements noted above and in addition, flow control and mixing means must be provided in order to meet the immersion lithography requirements and maintain a consistent medium allowing consistent repeatable lithography results.

In particular, the present invention provides an apparatus and method for supplying water and one or more dopants to the immersion lithography process. The system comprises a flow controller for the ultrapure water and for each dopant being combined. A flow controller may be any device or system that measures and controls the specific volumes of each fluid being combined. In addition, the apparatus and method of the present invention can include blending capability to ensure full and proper mixing of the fluids prior to delivery to the immersion lithography tool.

The dopants may be chosen in order to meet a specific index of refraction when combined with the ultrapure water. The dopant must be compatible and mixable with the ultrapure water and must also meet the requirements for any medium to be used in immersion lithography as noted above, i.e. low optical absorption at 193 nm, compatibility with the photoresist and the lens material, uniformity and non-contaminating.

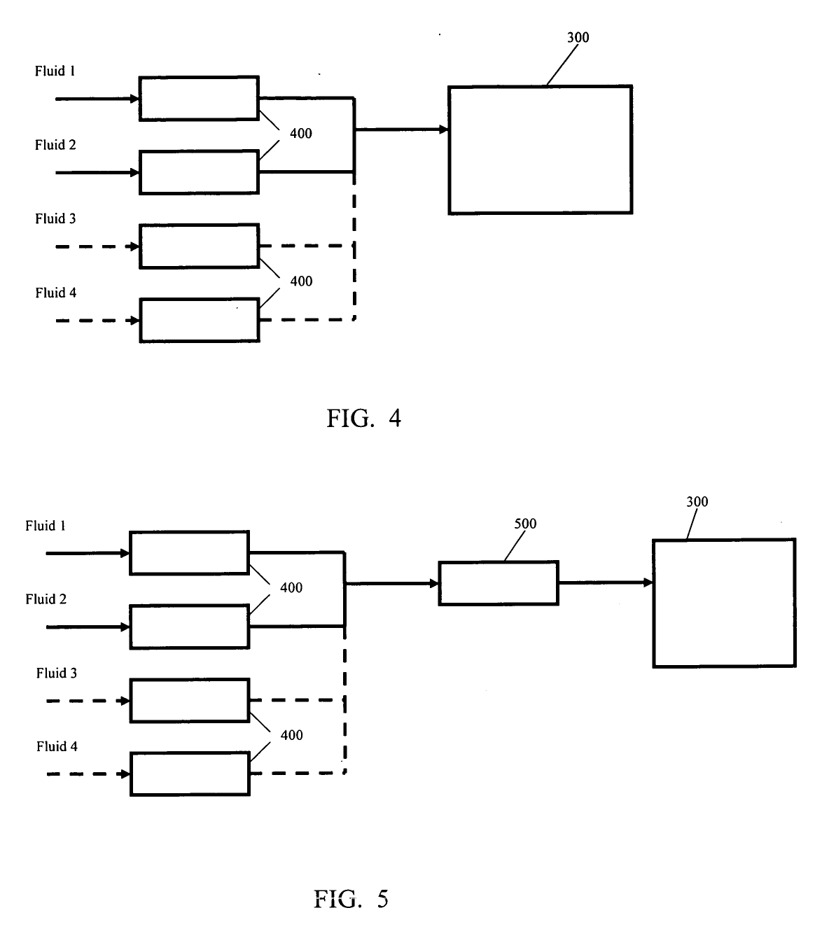

FIG. 4 shows one embodiment of the present invention wherein several fluids, including ultrapure water are provided to an immersion lithography tool 300. In particular, FIG. 4 includes a flow controller 400 for each fluid to be combined, e.g. ultrapure water and other fluids such as dopants. The dopants may be purified prior to entering their respective flow controller 400. The flow controllers 400 measure and control the specific volumes of each fluid being combined to meet the desired requirements for the combined fluid needed by the immersion lithography tool.

FIG. 5 shows a further embodiment of the present invention wherein a mixing device 500 is included to provide mixing of the fluids from the flow controllers 400 prior to delivery to the immersion lithography tool 300.

By using the apparatus and method of the present invention, ultrapure water that satisfies the requirements of immersion lithography can be consistently produced. Further, by providing all of the purification units in a single cabinet, such as a point-of-use cabinet, the ultrapure water can be supplied in a more convenient and economic manner.

It is anticipated that other embodiments and variations of the present invention will become readily apparent to the skilled artisan in the light of the foregoing description and examples, and it is intended that such embodiments and variations likewise be included within the scope of the invention as set out in the appended claims.

1. A system for providing ultrapure water to a immersion lithography device, the system comprising:
a prefilter in fluid communication with a water supply;
a reverse osmosis unit in fluid communication with the prefilter;
a deionization unit in fluid communication with the reverse osmosis unit;
an ultraviolet light unit in fluid communication with the deionization unit;
a filter in fluid communication with the ultraviolet light unit;
a degasser in fluid communication with the filter; and
an ultrafilter in fluid communication with the degasser;
wherein ultrapure water exits the system from the ultrafilter and may be used by the immersion lithography device.

2. A system according to claim 1, wherein the system is housed in a single cabinet.

3. A system according to claim 2, wherein the cabinet is a point-of-use cabinet.

4. A system according to claim 1, further comprising:
a storage vessel in fluid communication with the reverse osmosis unit; and
a pump in fluid communication with the storage vessel and the deionization unit.

5. A system according to claim 4, wherein the system is housed in a single cabinet.

6. A system according to claim 5, wherein the cabinet is a point-of-use cabinet.

7. A system according to claim 1, wherein the deionization unit, the ultraviolet light unit, the filter, the degasser, and the ultrafilter are housed in a single cabinet.

8. A system according to claim 7, wherein the cabinet is a point-of-use cabinet.

9. A system according to claim 1, wherein the reverse osmosis unit and the ultrafilter are in fluid communication with a system drain.

10. A system according to claim 4, wherein the storage vessel is in fluid communication with a system drain.

11. A system according to claim 1, further comprising means to add dopants to the ultrapure water.

12. A system according to claim 11, wherein said means includes flow controllers.

13. A system according to claim 12, wherein said means further includes mixing means.

14. A method of producing ultrapure water for an immersion lithography process, the method comprising:
treating a water supply by prefiltration to obtain prefiltered water;
treating the prefiltered water by reverse osmosis to remove ions and large molecules;
treating the water from the reverse osmosis process using ultraviolet light to remove impurities and suspend solids;
treating the water from the ultraviolet light process by filtration to obtain filtered water;
treating the filtered water by degassification to
treating the water from the degassification process to ultrafiltration to obtain ultrapure water.

15. A method according to claim 14, further comprising:
storing the water from the reverse osmosis process until requested for use by the immersion lithography process.

16. A method according to claim 14, further comprising:
adding a dopant to the ultrapure water.

17. A system for providing a medium having a specific predetermined refractive index to an immersion lithography device, the system comprising:
a source of ultrapure water;
a source of at least one dopant material; and
means for combining the ultrapure water and the at least one dopant material to obtain the medium.

18. A system according to claim 17, wherein said means for combining includes a separate flow controller for the ultrapure water and for each of the at least one dopant material.

19. A system according to claim 18, wherein said means further includes mixing means.

20. A method for providing a medium having a specific predetermined refractive index to an immersion lithography device, the method comprising:
providing a precise quantity of ultrapure water; and
adding a precise quantity of at least one dopant material to the ultrapure water to obtain the medium.

21. A method according to claim 20, wherein said adding is carried out using a separate flow controller for the ultrapure water and for each of the at least one dopant material.

22. A system according to claim 20, further comprising:
mixing the ultrapure water and the at least one dopant material.
